(19) United States
(12) Patent Application Publication
(10) Pub. No.: US 2014/0195518 A1
(43) Pub. Date: Jul. 10, 2014

(54) System and Method for Data Mining Using Domain-Level Context

(71) Applicant: Opera Solutions, LLC, Jersey City, NJ (US)

(72) Inventors: Herbert Kelsey, Wall Township, NJ (US); Anup Doshi, La Jolla, CA (US)

(73) Assignee: OPERA SOLUTIONS, LLC, Jersey City, NJ (US)

(21) Appl. No.: 14/147,988

(22) Filed: Jan. 6, 2014

Related U.S. Application Data
(60) Provisional application No. 61/748,837, filed on Jan. 4, 2013.

(51) Int. Cl. G06F 17/30

(52) U.S. Cl. CPC G06F 17/30539
USPC 707/722

(57) ABSTRACT

A system and method for data mining using domain-level context is provided. The system includes a computer system and a contextual data mining engine executed by the computer system. The system mines and analyzes large volumes of open-source documents/data for analysts to quickly find documents of interest. Documents/data are encoded into an ontological database and represented as a graph in the database linking contextual entities to find patterns and anomalies in context. Documents are separately analyzed by the system and scored on several different scales. The resulting information could be presented to the user via a visualization interface which allows the user to explore the data and quickly navigate to documents of interest.

### CROSS-REFERENCE TO RELATED APPLICATION

This application claims priority to U.S. Provisional Patent Application No. 61/748,837 filed on Jan. 4, 2013, which is incorporated herein in its entirety by reference and made a part hereof.

### BACKGROUND OF THE INVENTION

1. Field of the Invention

The present invention relates generally to systems for mining unstructured (e.g., open source) data. More specifically, the present invention relates to a system and method for data mining using domain-level context.

2. Related Art

Intelligence and security analysts face a daunting task of monitoring massive volumes of open source information from around the world in order to find the most interesting data, whether such data is threatening, influential, anomalous, and/or emotionally interesting. When considering social media, there are a number of analytic targets, such as the identification of sentiments, threats, topics, influencers, and trends. In each of these cases, identifying anomalous data requires more than a “bag-of-words” approach to feature detection. Where traditional approaches attempt to utilize natural language processing (NLP) with phrase or document-level contexts to boost performance, only limited improvements result compared to basic models.

Generally, isolated evaluation of data results in insufficient information to determine the degree of interest of a post, especially to a person interested in whether a post is anomalous, credible, or legitimate. However, such information can be determined by considering the context around the document. For example, consider the sentiment of the sentence, “Newt Gingrich's disregard for the struggle of blue-collar workers will lead to his downfall.” A basic supervised “bag-of-words” model would identify words and phrases correlated with a negative sentiment, such as “disregard,” “struggle,” and “downfall.” More advanced state-of-the-art approaches may consider the structure of the phrase and sentence with respect to the document. Information that can be gleamed using such approaches is that Newt Gingrich displays a negative sentiment towards blue-collar workers, and that the author may not think highly of Newt Gingrich. However, if the context of the document is evaluated, more information can be extracted from the data, such as if the blogger is “left-wing” (statement is “expected” and not substantial) or “right wing” (statement is “unexpected” and potentially substantial).

Any type of classification algorithm must reduce errors by several orders of magnitude to become tenable, especially considering the millions of blog posts and news articles created every day (e.g., Twitter alone produces over 140 million tweets per day), as well as the ever-growing world of open source, unstructured data. Current state-of-the-art sentiment analysis engines tend to reach an 80-90% accuracy in many domains. Text analytics algorithms, like sentiment analysis engines, struggle to take into account contextual information, such as the relationships between topics or authors, so that it is typically difficult to determine whether the document at hand is anomalous (e.g., unexpected sentiment or undue influence). Utilizing “domain-level” context-based information would more accurately mimic human expert knowledge, especially for understanding unstructured data.

### SUMMARY OF THE INVENTION

The present invention relates to a system and method for data mining using domain-level context. The system includes a computer system and a contextual data mining engine executed by the computer system. The system mines and analyzes large volumes of open-source documents/data for analysts to quickly find documents of interest. Documents/data are encoded into an ontological database and represented as a graph in the database linking contextual entities to find patterns and anomalies in context. Documents are separately analyzed by the system and scored on several different scales. The resulting information could be presented to the user via a visualization interface which allows the user to explore the data and quickly navigate to documents of interest.

### BRIEF DESCRIPTION OF THE DRAWINGS

The foregoing features of the invention will be apparent from the following Detailed Description of the Invention, taken in connection with the accompanying drawings, in which:

FIG. 1 is a diagram showing a general overview of the contextual data mining system;

FIG. 2 shows a “heatmap” visualization interface generated by the system;

FIG. 3 shows an example of processing of a search term by the translation and transliteration module;

FIGS. 4-5 are diagrams showing a general overview of contextual analysis performed by the system in connection with the sentiment of a document;

FIG. 6 is a diagram showing a complex traversal of the sentiment of a document performed by the system, using domain-level context to understand real-world sentiment queries;

FIG. 7 is a diagram showing a contextual graph generated by the system for analyzing influence;

FIG. 8 shows a domain-level contextual ontological graph generated by the system, and enlarged portions thereof;

FIG. 9 is a diagram illustrating a portion of an ontological graph generated by the system showing the relative sentiments and links between authors in a single online forum;

FIG. 10 is a flowchart showing steps carried out by the ontology scoring process of the system;

FIG. 11 is a flowchart showing steps carried out by the system for detecting anomalies;

FIG. 12 is an example of a set of links between a document and a contextual ontology; and

FIG. 13 is a diagram showing hardware and software components of the system.

### DETAILED DESCRIPTION OF THE INVENTION

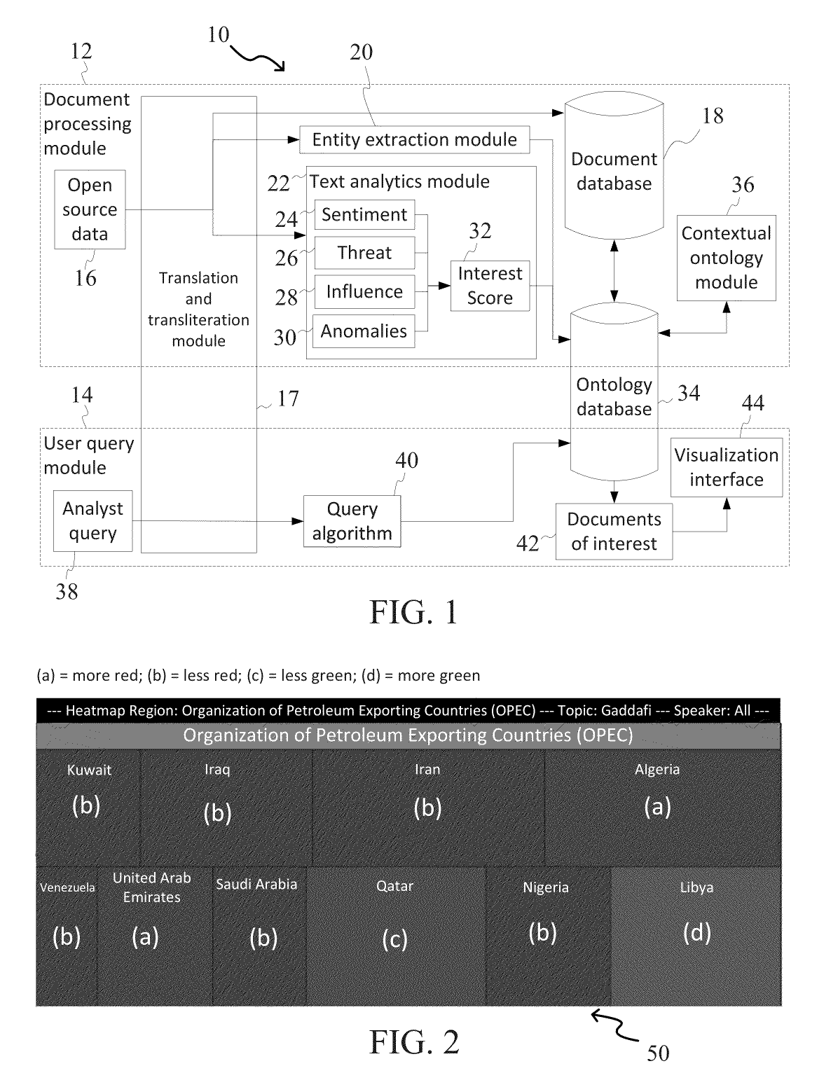

The present invention relates to a system and method for data mining using domain-level context, as discussed in detail below in connection with FIGS. 1-13.

The system of the present invention infuses language-based approaches (e.g., text analytics) to open-source data analysis with domain-level contextual analysis. The purpose of contextual analysis is to understand the context from which a document can be interpreted when viewed from a specific perspective. The system expands the scale of documents that can be analyzed, and allows an analyst (e.g., security analyst, intelligence analyst, etc.) to monitor activities and quickly identify the most interesting and/or anomalous documents to review. The system is agnostic to the underlying language-based approach, and thus is meant to augment and enhance processing of natural language data and improve performance thereof, particularly for anomalous data (e.g., unexpected or abnormal data). The system also incorporates knowledge engineering methods to more rapidly identify anomalous or interesting sentiments, threats, topics, influencers, and/or trends. The system can process large quantities of data to automatically score and find contextual anomalies, such as unexpected events or unexpected shifts in sentiment when a populace turns against its leadership.

As used herein, “domain-level context” is the knowledge and information surrounding authors, topics, locations, etc., especially regarding their relationships and history. This knowledge can include ontological representations (i.e., contextual relationships) of a variety of various entities pertinent to understanding open source data. There are many contextual relationships (e.g., geographical, geo-political, military, linguistic, religious, corporate, commercial, financial, industrial, etc.) that provide insight into understanding a particular document, especially considering that sentiments, threats, topics, influencers, and/or trends are not as interesting by themselves as they are in certain contexts. For instance, sentiments are more interesting if unexpected (e.g., a commonly expressed negative opinion is much more relevant if it comes from a previously positive source), threatening posts are more interesting if from a source with motive, opportunity, and ability to translate cyber statements into physical actions, and trends, memes, or other ideas spread across the Internet, are more interesting if they occur in a broader context of physical events.

FIG. 1 is a diagram showing a general overview of the contextual data mining system 10 of the present invention. The contextual data mining system 10 utilizes a document processing module 12 and a user query module 14 to provide document collection, document analytics, ontology encoding, querying algorithms, and an interactive interface, among other functions. The modules 12, 14 could be coded in any suitable high- or low-level programming language and executed by one or more computer systems. The document processing module 12 allows for efficient and effective processing of massive amounts of multilingual documents/data 16 (e.g., text data, social media, blogs, news, proprietary forums, posts, feeds, etc.). The document processing module 12 compiles documents/data 16, such as by electronically collecting news feeds from various media sources (e.g., large-scale news outlets, small news feeds, public blogs, etc.) from various countries around the world. The data 16 is translated by a translation and transliteration module 17, discussed below in more detail, and then stored in a document database 18.

The documents/data 16 are individually processed (e.g., text mined) by an entity extraction module 20 to identify various entities (e.g., author, subjects/topics, locations, etc.) within the document. For instance, topics could be identified using term matching. The documents/data 16 are also individually processed by a text analytics module 22 utilizing one or more sets of text analytics algorithms (e.g., sentiment algorithm 24, threat algorithm 26, influence algorithm 28, anomalies algorithm 30, etc.) to extract sentiments, threats, influences, anomalies, etc., to calculate a corresponding interest score 32 (e.g., interest score, analytical score, document-based score). The interest score 32 can be the quantitative output of any one of the set of text analytics algorithms (e.g., sentiment algorithm 24, threat algorithm 26, influence algorithm 28, etc.), could itself be a set of outputs of the text analytics algorithms, or a combination of such scores into an aggregated interest score. The interest score 32 represents the document-driven analysis from analyzing the document by itself, without context.

The system 10 provides a scalable taxonomy-based method for developing and incorporating new types of analytic scores (e.g., from new types of algorithms), particularly for distinguishing threats of new extremist groups (e.g., capturing words and phrases domain experts consider most relevant to the extremist groups). Documents/data 16 could be analyzed by the sentiment algorithm 24, which could be trained using an internally developed corpus of data. Such a sentiment algorithm 24 could have “bag-of-words” features including TF-IDF (term frequency-inverse document frequency) with N-grams, and could be classified using a series of support vector machines (SVM). Using such a sentiment algorithm 24, cross-validation achieved approximately 80% accuracy in identifying positive or negative sentiments. Further, deep linguistic analysis could be applied to more accurately reveal sentiments, threats, influences, anomalies, and/or other analytic targets between entities within a document.

The sentiment and threat algorithms (or other text analytic algorithms) could include a feature creation that utilizes corpus-based TF-IDF and/or taxonomy-based TF-IDF (to suit multilingual features), and have classifiers such as Multinomial Naïve Bayes, Random Forests, and/or SVMs. The taxonomy could be based on a proprietary set of words or phrases that are labeled and translated by domain experts, and could be used to train text analytic algorithms (e.g., threat algorithm). As another example, the influence algorithm could generate an influence score based on the number of responses and/or references to a particular post (i.e., direct influence), which could be modified to include any subset of direct, indirect, and/or structural influences, discussed in more detail below. Further descriptions of analysis algorithms (e.g., sentiment algorithms) applicable to the present invention include Olivier Grisel, “Statistical Learning for Text Classification with scikit-learn and NLTK,” PyCon (2011), http://www.slideshare.net/ogrisel/statistical-machine-learning-for-text-classification-with-scikitlearn-and-nltk; “Text Classification for Sentiment Analysis—Naïve Bayes Classifier,” StreamHacker, http://streamhacker.com./2010/05/10/text-classification-sentiment-analysis-naive-bayes-classifier/; Pang, et al., “Opinion Mining and Sentiment Analysis, Foundations and Trends in Information Retrieval, Vol. 2, Nos. 1-2 (2008), http://www.cse.iitb.ac.in/˜pb/cs626-449-2009/prev-years-other-things-nlp/sentiment-analysis-opinion-mining-pang-lee-omsa-published.pdf, the disclosures of which are incorporated herein by reference.

After the documents/data 16 are processed through the text analytics module 22, the documents/data 16 are subsequently post-processed through, and encoded into, an ontology database 34 utilizing a large archive of historical data. The ontology database 34 is used to provide contextual analysis (such as for text mining open-source data) to determine data-driven context (e.g., contextual sentiment) because contextual analysis is more sophisticated and variable than static, document-driven analysis, and thereby requires a formalized structure for the various documents, authors, and relationships between authors, countries, regions, etc.

The ontology database 34 stores one or more contextual ontologies, where an ontology represents expert knowledge (e.g., domain expertise of intelligence analysts) and provides domain-level contextual features for anomaly detection and classification in open source data. Ontologies, especially when first populating the ontology database 34, could automatically be generated from open sources (e.g., CIA Factbook). Each document/data 16 can be linked to an ontology by linking that document with a set of similar documents using each type of entity (e.g., authors, topics, locations, etc.) previously identified and extracted by the entity extraction module 20. The links within a contextual ontology are represented as a graph stored in the database 34 and connecting contextual entities (i.e., contextual graph). The entire ontology for open source data could contain over several hundred thousand nodes and connections used to represent the relationships between references in the documents/data 16, and capturing the sentiment and strength thereof, as well as other necessary information to accurately exploit the documents/data 16. Applications of the ontological database 34 include finding patterns, detecting anomalies in context (e.g., anomalous sentiments and trends), and finding relevant influencers and threats. For example, a geo-politically centered contextual ontology could be developed for understanding all open source data (e.g., open source news, blog data, etc.), which would be particularly advantageous for intelligence and government analysts.

Each link (i.e., connection) between entities (i.e., nodes) in the ontology has one or more corresponding link scores (e.g., sentiment link score, threat link score, influence link score, etc.), where each link score could also be distinguished by how it was calculated (e.g., Document-Based Link Scores (DBLS), Ontology-Based Link Scores (OBLS), and/or Expert-based Link Scores (EBLS)), as discussed in more detail below. These link scores are calculated by, and periodically or continuously updated by, the contextual ontology module 36, also discussed in more detail below, and could represent the overall strength of sentiments, threats, influences, anomalies, etc. between entities.

As each document/data 16 is linked and placed in context in the ontology, a simple traversal over the graph of the contextual ontology (i.e., contextual graph) can provide interesting information about the documents and queries at hand. For instance, consider a document that refers to both Iraq and Israel, where the ontology is traversed on various levels, as shown below:

TABLE 1
Iraq - DBLS [−1] - Israel
Iraq - religion [97.0] - Muslim - DBLS [−1] - Israel
Iraq - DBLS [−1] - other - religion [3.8] - Israel
Iraq - DBLS [−1] - Jewish - ethnicity [76.4] - Israel
Iraq - DBLS [−1] - Jewish - religion [75.6] - Israel
Iraq - DBLS [−1] - Christian - religion [2.0] - Israel
Iraq - DBLS [−1] - other - sub-rel - Druze - religion [1.7] - Israel
Iraq - DBLS [−1] - other - sub-rel - other - religion [3.8] - Israel
Iraq - DBLS [−1] - Jewish - sub-rel - Jewish - ethnicity [76.4] - Israel
Iraq - DBLS [−1] - Jewish - sub-rel - Jewish - religion [75.6] - Israel
Iraq - DBLS [−1] - Christian - sub-rel - Christian - religion [2.0] - Israel
Iraq - religion [97.0] - Muslim - DBLS [−1] - other - religion
[3.8] - Israel
Iraq - religion [97.0] - Muslim - DBLS [−1] - Jewish - ethnicity
[76.4] - Israel
Iraq - religion [97.0] - Muslim - DBLS [−1] - Jewish - religion
[75.6] - Israel
Iraq - religion [97.0] - Muslim - DBLS [1] - Christian - religion
[2.0] - Israel

By traversing the ontology on various levels, an understanding of the relationship between these entities can be derived, as discussed below in more detail.

A user query module 14 is provided to allow analysts to interact with the system 10 and issue queries 38 for documents of interest by topic, author, location, interest score, and/or interest score type, among others. The invention is not limited to manual analyst queries, and could be utilized with automatic anomaly detection systems. An analyst makes a query 38, such as by topic, author, location, and/or score, and then the query is translated by module 17, if required. The translation and transliteration module 17 (e.g., Google Translate API) processes multilingual analyst queries 38 and data 16 (e.g., multilingual online forums), and is discussed in more detail below.

After the analyst query 38 is translated by the translation and transliteration module 17 (if needed) a query algorithm 40 is created based on the analyst query 38 and then sent to the ontology database 34. The ontology database 34 processes the query algorithm 40 using the contextual ontologies, retrieves any relevant information (e.g., documents of interest 42) from the document database 18. An example query algorithm for the analyst query “How do OPEC countries feel about Gaddafi?” is shown below:

TABLE 2

Query: talker: OPEC, topic: Gaddafi
start a=node(OPEC), b=node(Gaddafi)
match p=a-[:in]-cou<-[:location]-docs-[:topic]->b
return cou, docs.score

In this example, the query algorithm finds the countries in OPEC, compiles documents from those countries, selects those documents that have Gaddafi as a topic, and returns the score for each document and the country associated with it. The resulting information could be presented to the analyst by a visualization interface 44 which allows the user to visualize and explore the data and analytics, as well as quickly navigate to and compare the documents of interest. The visualization interface 44 could be a “heatmap” visualization interface as discussed in detail below, or any other type of visualization format capable of conveying results to an analyst.

FIG. 2 shows a “heatmap” visualization interface 50 generated by the system to easily traverse a graph of a contextual ontology, although any suitable type of interface could be used. The results of a query, including an aggregate link score on all relevant documents for each pair of entities, could be visually displayed in the interface 50. For example, the interface could graphically display the areas in the world of greatest interest. The query for the interface 50 shown in FIG. 2, based on the query of Table 2 above, includes countries in OPEC (Organization of the Petroleum Exporting Countries) as the “authors” and Gaddafi as the “subject,” where the sentiments (i.e., aggregate link scores between entities compiled from multiple documents) are displayed by colors as in a heatmap (e.g., shades of red and green consistent with, respectively, the spectrum of negative and positive sentiment). Additionally, or alternatively, the sentiments from the resulting countries could be displayed on the interface as a numerical value (e.g., negative numbers indicate negative sentiment and positive numbers indicate positive sentiment). As shown, Libya (of which Gaddafi was a former leader) stands out as having much more positive sentiment compared with the remainder of the group. This abnormality, in actuality representing a view of events on the ground in these countries, could warrant further investigation by an analyst.

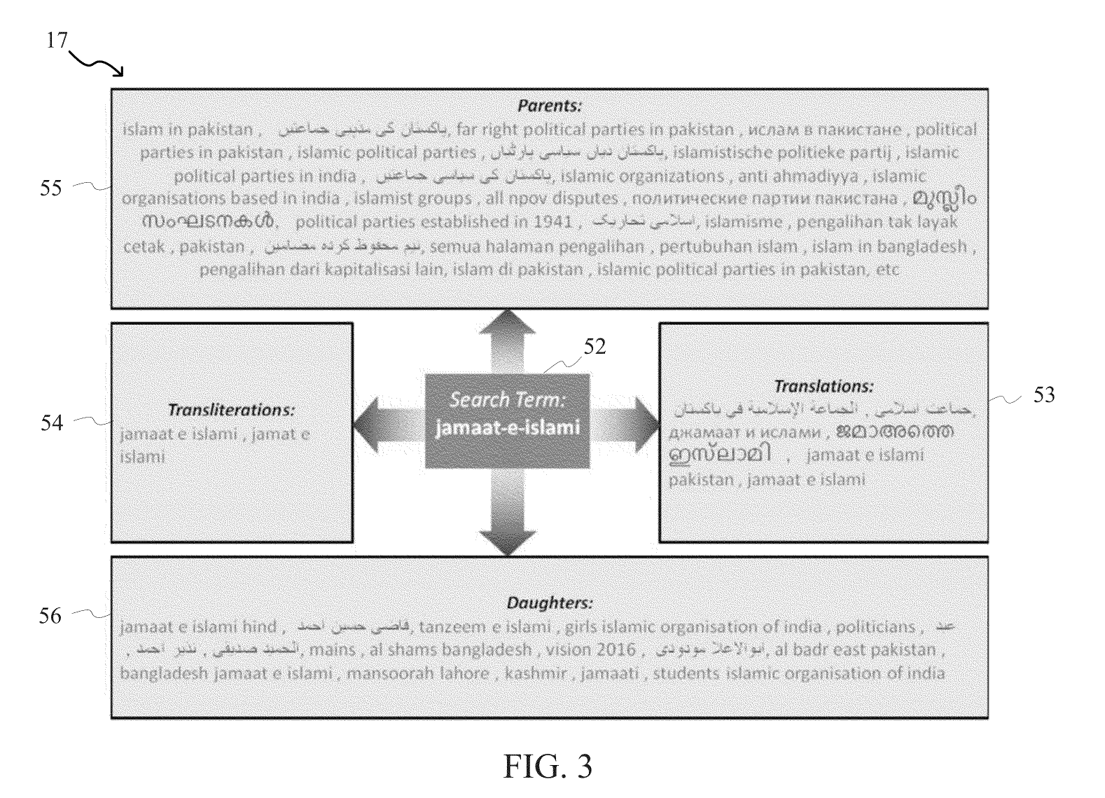

FIG. 3 shows an example of processing of a search term by the translation and transliteration module 17. The translation and transliteration module 17 utilizes a database that mines sources (e.g., Wikipedia) to learn transliterations between key words and phrases in multiple languages (and even within languages), and then detects various words and phrases that correspond to terms of interest in English, which expands the scope of the ontology. The module could obtain Wikipedia-based parent/daughter relationships for search terms and entities within the ontology. The module expands the scope of the ontology, effectively multiplies the search space, and increases coverage of each node in the contextual graph. For example, for the search term “jamaat-e-islami” 52, the module 17 utilizes translations 53, transliterations 54, parent relationships 55, and daughter relationships 56. In such an example, the search term “jamaat-e-islami may be an entity in the contextual ontology, and as new documents are added to the document database, they are matched to this entity by searching for any of the terms returned by the module 17.

Concurrently, a phrase taxonomy could be utilized, in conjunction with domain experts, to identify the strength of sentiment of particular words of contextual interest. In this way, the system is agnostic to the underlying language of a document because the underlying entity extraction module 20 and text analytics module 22 rely on pre-defined multilingual taxonomies, and the system 10 facilitates approximate detection of negative sentiment in multilingual data. For example, a Jihadi phrase taxonomy could be built in conjunction with domain experts to train a model that identifies the most threatening statements based on word appearances. Such an approach could utilize a bag-of-words model with TF-IDF features on the taxonomy, coupled with a Multinomial Naïve Bayes model. Training the model on expertly labeled Jihadi forum data could achieve an average cross-validation accuracy or equal error rate (EER) of 84%. The model could allow for the automatic detection of Jihadi threats in multilingual data. This method of proprietary expert taxonomy for building a multilingual Jihadi threat model could then be easily expanded to any other set of actors, such as violent actors, extremist actors, non-state actors, hacktivists (e.g., Anonymous), narco-cartels, separatist groups, etc.

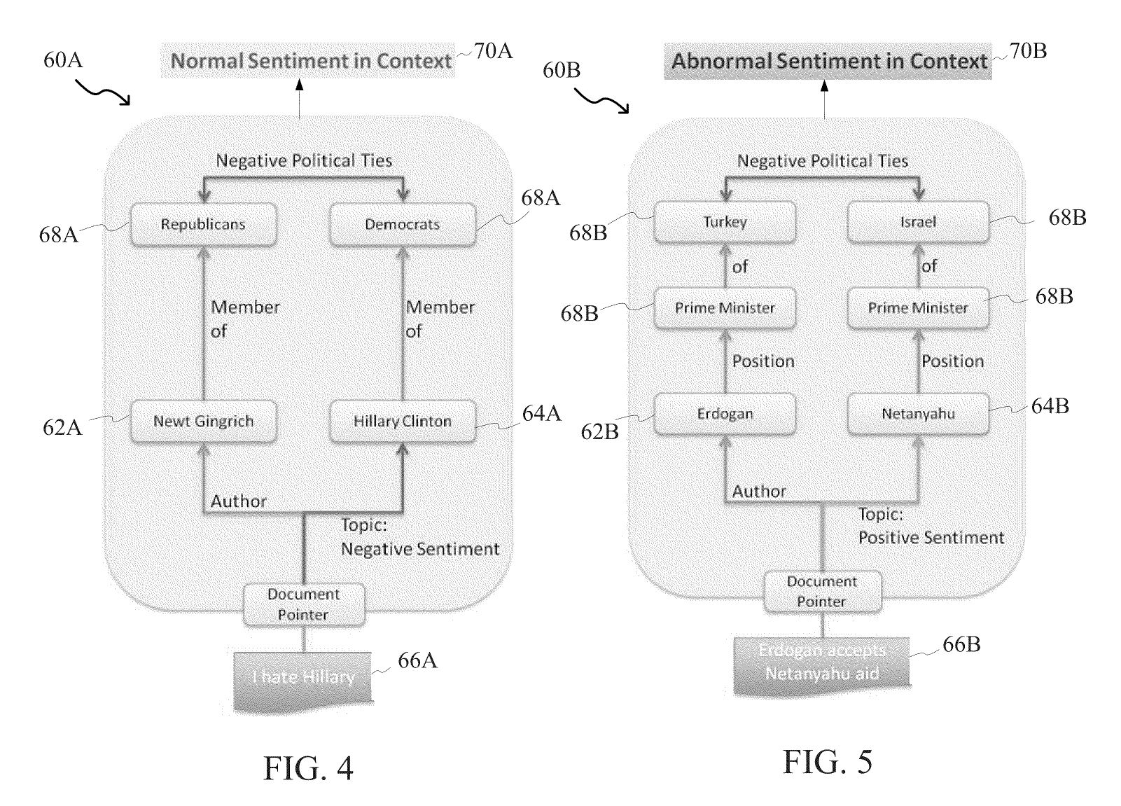

FIGS. 4-5 are diagrams showing general overviews 60A, 60B of contextual analyses performed by the system for analyzing the sentiment of documents. In FIG. 4, assume a query where the speaker/author 62A is Newt Gingrich, the subject/topic 64A is Hilary Clinton, and the document/data 66A is the statement “I hate Hilary.” The document-driven sentiment result is derived from the document itself using the text analytics module of the system, and is determined to be a negative sentiment (i.e., Newt Gingrich (author)→negative to→Hilary Clinton (subject)). The contextual sentiment is derived from examining external data 68A using the ontology database of the system, and is also determined to have a negative sentiment (i.e., Newt Gingrich→Republican→negative to→Democrats→Hilary Clinton). The sentiment in context 70A is normal because the open source sentiment and the context are both negative. Thus, the document/data 66A is not particularly interesting in context because the statement is expected since Republicans are generally not fond of Democrats. In other words, a simple negative statement by the author about a subject is in some sense congruent with the contextual sentiment between the affiliations of the author and subject.

Comparatively, in FIG. 5, assume a query where the speaker/author 62B is Recep Tayyip Erdogan, the subject/topic 64B is Benjamin Netanyahu, and the document/data 66B is the statement “Erdogan accepts Netanyahu aid.” The sentiment in context 70B is abnormal because the document-driven sentiment is positive (i.e., Erdogan→positive to→Netanyahu) and the contextual sentiment is negative (i.e., Erdogan→Prime Minister→Turkey→negative to→Israel→Prime Minister→Netanyahu). Thus, the document/data 66B is interesting in context because the statement is unexpected since the author and subject are prime ministers of countries with negative political ties. The positive sentiment from the document stands in contrast to the negative sentiment from the context of the document which includes information about the locations of the author and the subject. Contextual sentiment between the two locations could provide useful information to help understand a particular document/data 66B, especially if the author 62B and subject 64B are particularly tied to their respective locations.

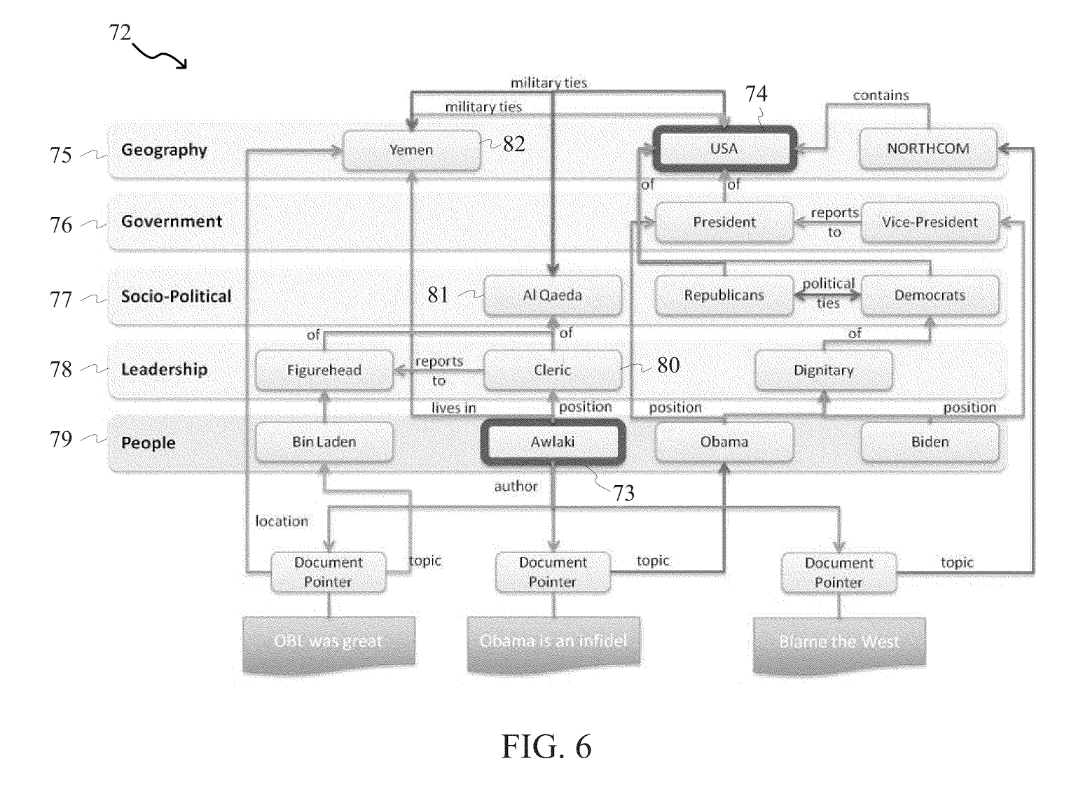

FIG. 6 is a graph 72 of an ontology generated by the system and depicting complex contextual analysis of sentiment. Although sentiment is analyzed, the graph could be used and traversed to understand threats, influences, and/or trends, among other analytic targets. Assume there is a document with Anwar Awlaki 73 as the author and with the USA 74 as the subject. As shown, there are multiple relationship paths between a variety of types of contextual relationships (e.g., geography 75, government 76, socio-political 77, leadership 78, people 79, etc.) that can help understand the contextual sentiment between Awlaki 73 and the USA 74. In this case, most of the documents and contexts from the ontological database imply a negative relationship between Awlaki 73 and the USA 74 (e.g., Awlaki 73 was a Cleric 80 with Al-Qaeda 81, which has declared war on the USA 74), except the relationship between Yemen 82 and USA 74 (e.g., Awlaki 73 lived in Yemen 82 which cooperates militarily with the USA 74), which may deserve more attention by an analyst. These relationships encompass socio-political and geo-political ontologies, among other ontologies, to provide contextual sentiment. Different relationships imply varying strengths of connection (e.g., “lived in” may be less informative than “leader of”). As a result, many of the links in these paths can be colored by sentiment and strength. By encoding ontological relationships in a graph database, discovery of relevant relationships and traversal of the graph 72 is straightforward. By combining the weighted sentiment of each relationship path and comparing across relationship paths, odd or anomalous documents/data (or relationship paths) are easy to identify. Moreover, the same structure can be used to traverse the document-driven sentiment, such as where Awlaki 73 wrote about topics associated with the USA 74 (e.g., Awlaki 73 wrote negatively about the President of the USA 74, or Awlaki 73 wrote negatively about a region of the world that includes the USA 74).

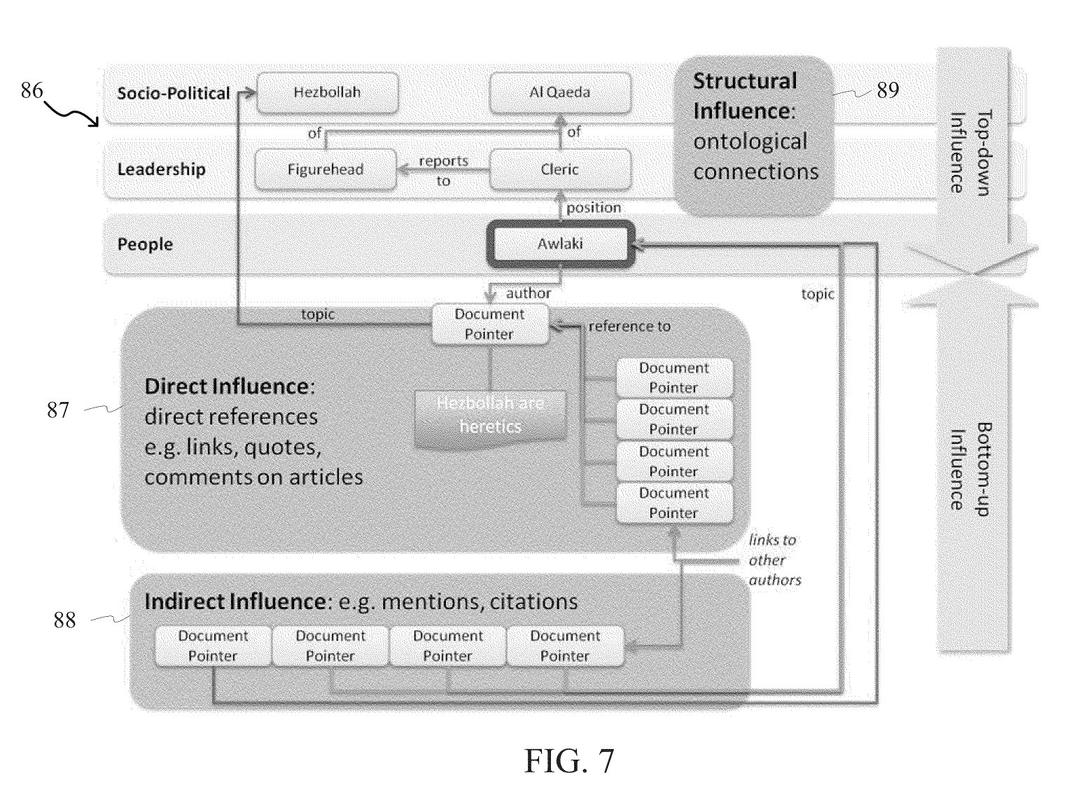

FIG. 7 is a graph 86 of an ontology generated by the system for understanding influence. Influence can be demonstrated in several ways, including through direct influences 87, indirect influences 88, or structural influences 89. For example, a corpus of documents written by Obama may be considered influential by virtue of the number of citations, or by virtue of the leadership position of the author. Further, for a more robust influence analysis, the weighted contextual sentiment (i.e., average link score) of the ontology links (i.e., link scores) could be incorporated, along with the document-driven sentiments of the corpus of open source documents under study.

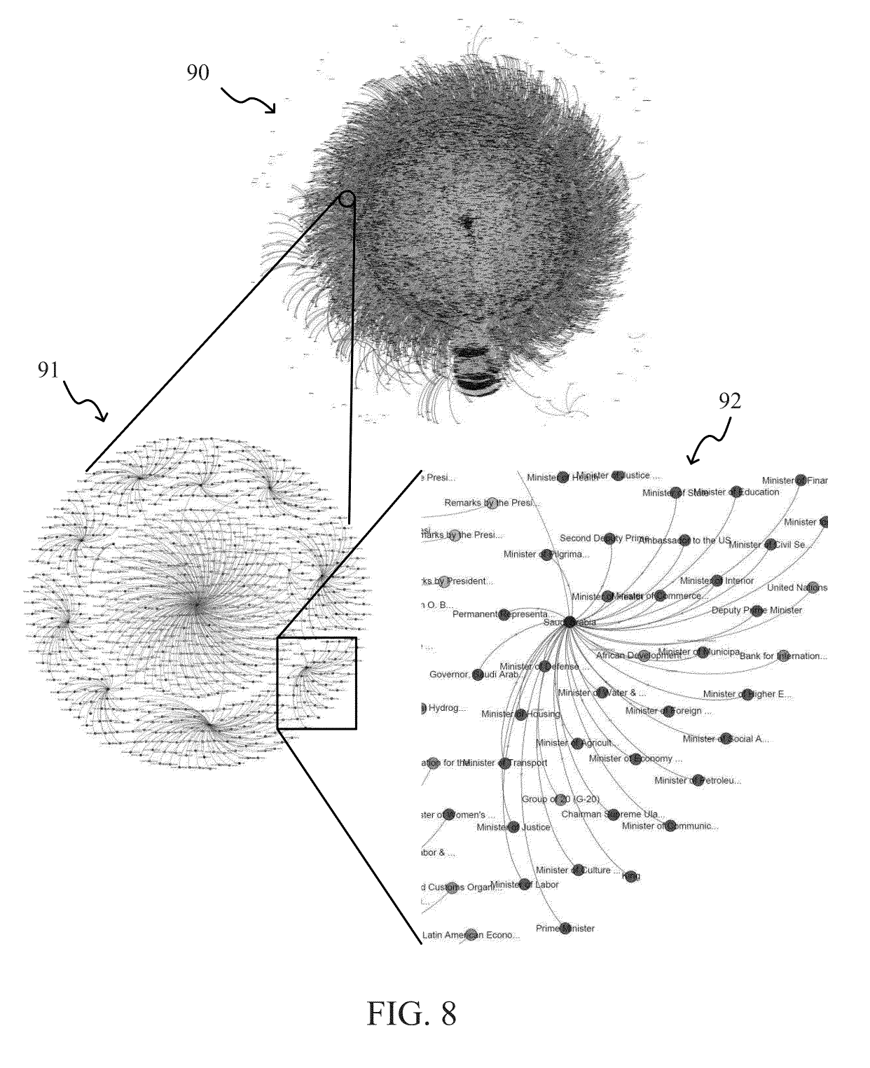

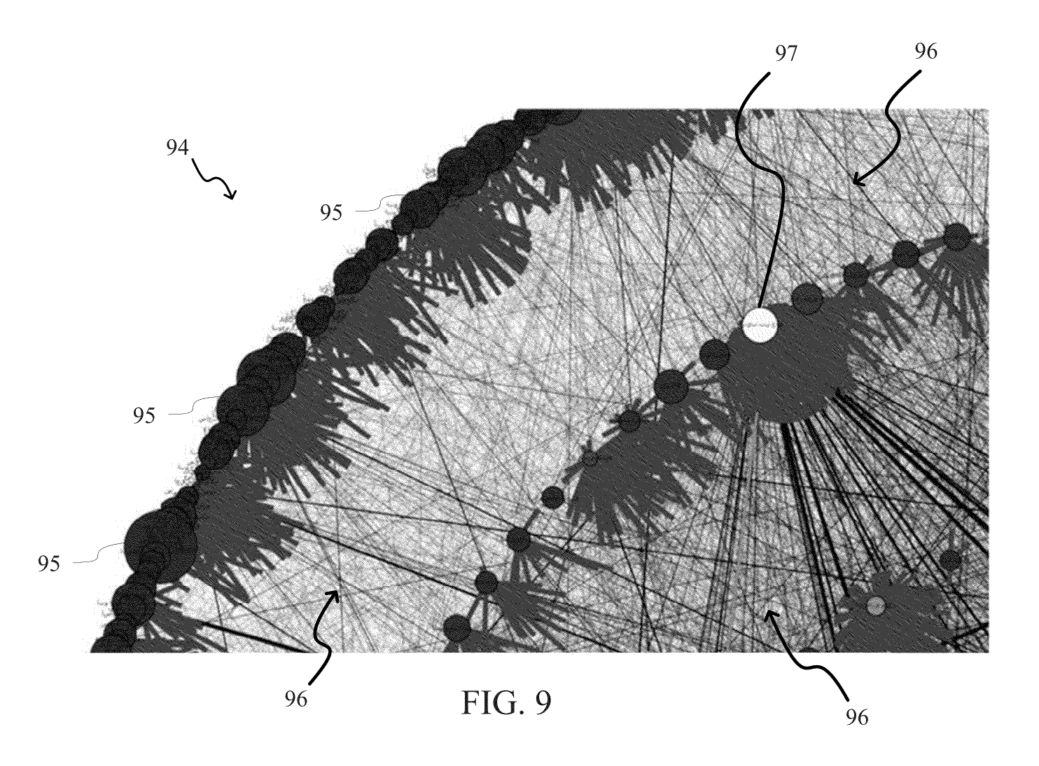

FIG. 8 shows a domain-level contextual ontological graph 90 generated by the system, and enlarged portions thereof. Such a graph 90 could be built in using commercially-available NoSQL Graph Database, neo4j, etc. As shown, the system could comprise a location centered (e.g., country) ontology and encode the relationships between locations, authors, and subjects. To encode the ontologies, existing databases (e.g., CIA, Wikipedia, Freebase, etc.) are mined to take advantage of existing open source domain knowledge. As mentioned above, ultimately, a graph database is built which facilitates linking entities, traversing contexts, and processing and understanding open source documents.

As shown in the exemplary ontological graph 90, the structure of a country, and its relationship to other countries and institutions in the world, is defined. The graph 90 also incorporates groupings that cross nation, state, and geographic boundaries, where such groupings are essentially any clustering that could unify a set of policies or actions, such as those based on religious faction, political alignment (e.g., North Atlantic Treaty Organization (NATO), etc.) and economic policy (e.g., European Union (EU), International Monetary Fund (IMF), G20, etc.). By incorporating these various alignments, structural tensions or compatibilities between them are addressed that inform the contextual analysis. The same can be said within a country where the policies and people in leadership are organized, such as political (e.g., majority or minority), military, religious, industrial, financial, royal, or judicial institutions, among other institutions.

Enlarged contextual graph 91 shows a portion of the geo-political context devoted to OPEC. The clusters are the countries in OPEC, the spirals (i.e., links) around each country represent their various leadership positions within each government as well as their connection to other organizations in the world, such as the G20 or the African Union. If the links were taken one step deeper to show another level of detail, the individuals that filled the government positions (e.g., names of current Government ministers), and additional religious, ethnic, linguistic, geo-political (e.g., memberships in other political organizations) connections would be displayed. Enlarged portion 92 shows a closer look at the OPEC portion of the graph and shows some of Saudi Arabia's context within the system.

FIG. 9 is a portion of an ontological graph 94 generated by the system, showing the relative sentiments and links between authors 95 in a single online forum, based on six months of data from January to June of 2011. The authors 95 with more negative sentiments (i.e., inflammatory users) are more red, and those with higher authorship have larger sizes in the graph 94. Links 96 between authors 95 depict conversations. Those authors 95 who have sparked the most conversation (i.e., structural and/or direct influence) and have the most negative writings (i.e., sentiment) are influencers 97 and are clearly visible and markedly interesting.

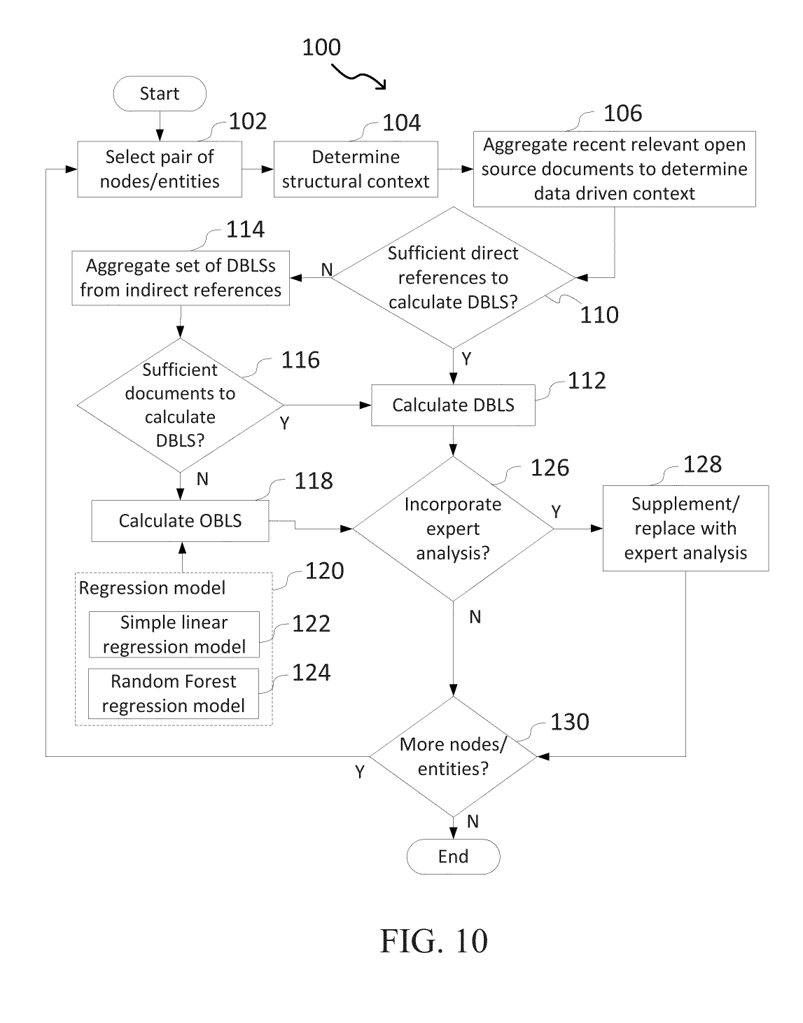

FIG. 10 is a flowchart 100 showing steps of the ontology scoring process carried out by the system for calculating link scores between entities in an ontology. Starting in step 102, a pair of nodes/entities within an ontology are selected. As described above, the ontology database is a networked database of nodes linked by structural context (i.e., objective relationships), containing information on a variety of subjects (e.g., countries, languages, ethnicities, religions, governments, authors, infrastructure, etc.) derived from a number of sources (e.g., CIA World Factbook). Each of the units in the database are stored as nodes and are linked to a set of other nodes by objective relationships (e.g., node: Botswana—relationship: religion [percentage: 71.6%]—node: Christian). In step 104, the structural context is determined, where the structural context is a reflection of the general state of the world as supported by factual sources. However, the structural context alone does not capture the current sentiment or state of affairs between two entities/nodes in the database. For example, the current relationship between Yemen and the United States may be needed in order to help analyze a document that comments about the pair of countries.

In step 106, recent relevant open source documents are aggregated to determine the data-driven context. The data-driven context is used to infer subjective relationships of each pair of entities in the ontology, such as by aggregating the individual sentiments of a large set of recent, open source documents about each pair of nodes (i.e., documents that refer to both entities). The data-driven context is a reflection of the current state of affairs between two entities/nodes, as seen by a group of authors of recent open source documents from around the world. As mentioned above a link score represents the overall strength of sentiments, threats, influences, anomalies, etc. between entities. Thus, in the contextual ontology, there could be more than one type of link score connecting two nodes (e.g., a sentiment link score, a threat link score, an influence link score, etc.), and, as discussed below, the link scores can also be distinguished by how they are calculated (e.g., DBLS, OBLS, and EBLS). However, even though the link scores may be calculated in different ways, each link score represents the relationship between two entities (e.g., sentiment, threat, influence, etc.).

To encode the data-driven context into the ontology, in step 110 a determination is made as to whether there are sufficient direct references to calculate a Document-Based Link Score (DBLS). A DBLS represents the strength of the direct or indirect relationship (e.g., sentiment, threat, influence, etc.) between two entities and is calculated using the aggregated recent and relevant open source documents. If there are sufficient direct references, the DBLS is calculated in step 112, and the data-driven context is encoded into the ontology database via the DBLS. For example, for a set of documents that refer to both Yemen and USA, the average sentiment of these documents is calculated (assuming a sufficient quantity of documents) and stored as the DBLS between Yemen and the USA. Thus, the link score for specific entities within an ontology could be aggregated from multiple documents examining the same relationship. For the more abstract pairs of entities (e.g., religions), there may not be sufficient direct references in the open source corpus. If there are not, the set of DBLSs that indirectly link the two nodes are aggregated in step 114. For example, the DBLS between the religions of Christianity and Islam could be inferred from the aggregate of a set of DBLSs between all majority Christian countries and all majority Muslim countries. In step 116, a determination is made as to whether there are a sufficient amount of documents to calculate a DBLS. If so, a DBLS is calculated in step 112.

Many pairs of countries may not have a sufficient number of documents to make a good estimate of the data-driven context via the DBLS. If there are not, a regression-weighted Ontology-Based Link Score (OBLS) is calculated in step 118. An OBLS also represents the strength of the relationship between two entities, but is calculated using statistical models utilizing structural context. Even though some pairs of countries have insufficient documents to calculate a DBLS, all pairs of countries have some structural context, derived from common United Nations Groups, religions, languages, ethnicities, etc. A regression model 120 can be utilized to analyze the correlation between the structural context and the data-driven context. At the same time, the regression model 120 determines the weights of the contextual features which lend themselves to predict DBLSs for links that do not have them. For example, a simple linear regression model 122 could be applied between the number of common ontological links of each type and the DBLS for those pairs where they exist, where the correlation coefficient could be 0.2, which trends towards significance. Alternatively, a more complex Random Forest regression model 124 could be used, where the correlation could increase to 0.75. The OBLS calculation could be further extended by incorporating missing-data techniques to fill in remaining knowledge, such as Expectation Maximization or other Bayesian methods. Further, the OBLS score could be calculated to supplement a DBLS score.

After a DBLS is calculated in 112, or an OBLS is calculated in 118, a determination is made in 126 as to whether to incorporate expert analysis (i.e., a human expert encoding their knowledge of these relationships into the ontology). If so, the DBLS or OBLS links between entities can be supplemented or replaced by expert analysis in step 128 by calculating an Expert-based Link Score (EBLS), which could be correlated with the DBLS and/or OBLS. The EBLS also represents the strength of the relationship between two entities, but is calculated based on an expert's input (e.g., manual entry of a link score, entry of private documents, etc.). The contextual ontology module allows for annotations of domain experts, as another way of encoding and applying domain expertise. In this way, a human expert could interact with, and update, the contextual ontologies in the ontology database with more recent or accurate data than that derived from open source data. In step 130, a determination is made as to whether there are more nodes or entities to analyze. If there are, the process repeats from step 102, and if not, the process ends. As mentioned above, these link scores could be for sentiments, threats, influences, anomalies, etc. so that one link between entities could have several types of link scores.

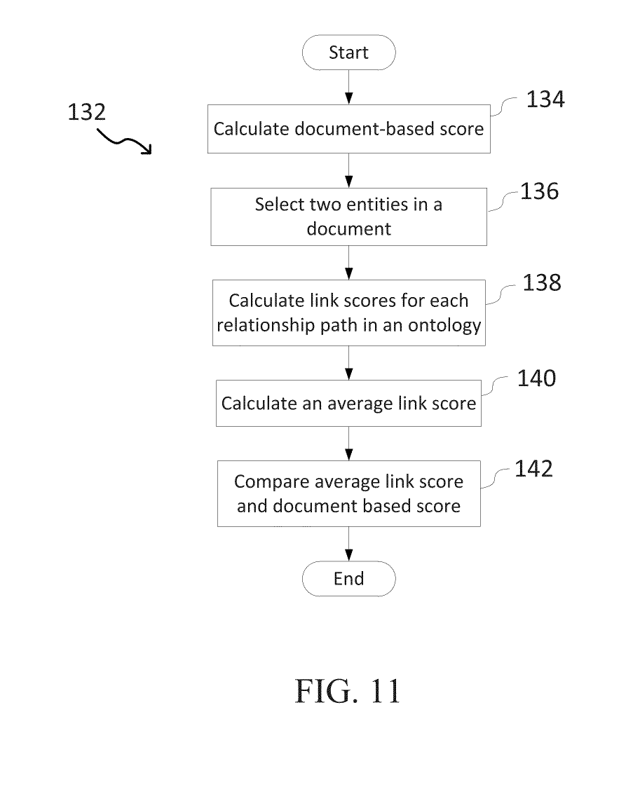

FIG. 11 is a flowchart 132 for detecting anomalies. For anomaly detection, the document-driven analysis needs to be compared to the data-driven analysis derived from the ontology. This process could be executed as a result of a user query, or could be performed automatically for every document entering the ontology database. In step 134, at least one type of document-based score (i.e., interest score) is calculated. In this way, for example, the overall sentiment of the document itself could be used as a proxy for understanding the entities within the document. In step 136, two entities in the document are selected. The selection could be automatic (e.g., based on text analytics) or could be based on a user query. In step 138, a pairwise set of link scores are calculated and are based on the various relationship paths that directly or indirectly link the pair of entities in an ontology. In step 140, an average link score is calculated by aggregating the link scores, preferably of the same type (e.g., sentiment, threat, influence, etc.), of the various relationship paths in step 138 in a weighted fashion, such as based upon the weights of the other links in the relationship path between the entities (e.g., using a regression model). More specifically, the average link score could be a weighted average of all pairwise DBLS, OBLS, and EBLS scores between the entities. This provides overall contextual information regarding the pair of entities, and is calculated to understand the context of the document itself.

For a document with more than two entities, an average link score could be calculated (although not required) for each pair of entities. Alternatively, the system could automatically determine, or the user could select, the most important pair of entities of interest within the document. Optionally, a contextual document score could be calculated to understand the context of the document as a whole by aggregating the average link scores for the various pairs of entities within a document. The average link scores of each pair of entities and/or the contextual document score provide a summary of the contextual knowledge surrounding the document, such as the expected sentiment, influence, threat, etc. of the document.

In step 142, the “distance” of the document-based score, S_{d}, is analyzed and compared to the average link score(s), S_{LS}, (and/or contextual document score) derived from the contextual ontology. In this way, using a Gaussian model, an S_{d} which is more than three standard deviations from the average link score (and/or contextual document score) could be determined to be an anomaly. For example, consider a document titled, “US military chief holds talks in Israel on Iran,” which has a document-based sentiment score S_{d}=−0.07 (calculated using a standard sentiment analysis algorithm), and an average link score of S_{LS}=−0.16. In this example, there is no anomaly because the document-driven sentiment is consistent with the contextual sentiment. Determining such anomalies provides the same knowledge that an expert may bring when analyzing open source documents.

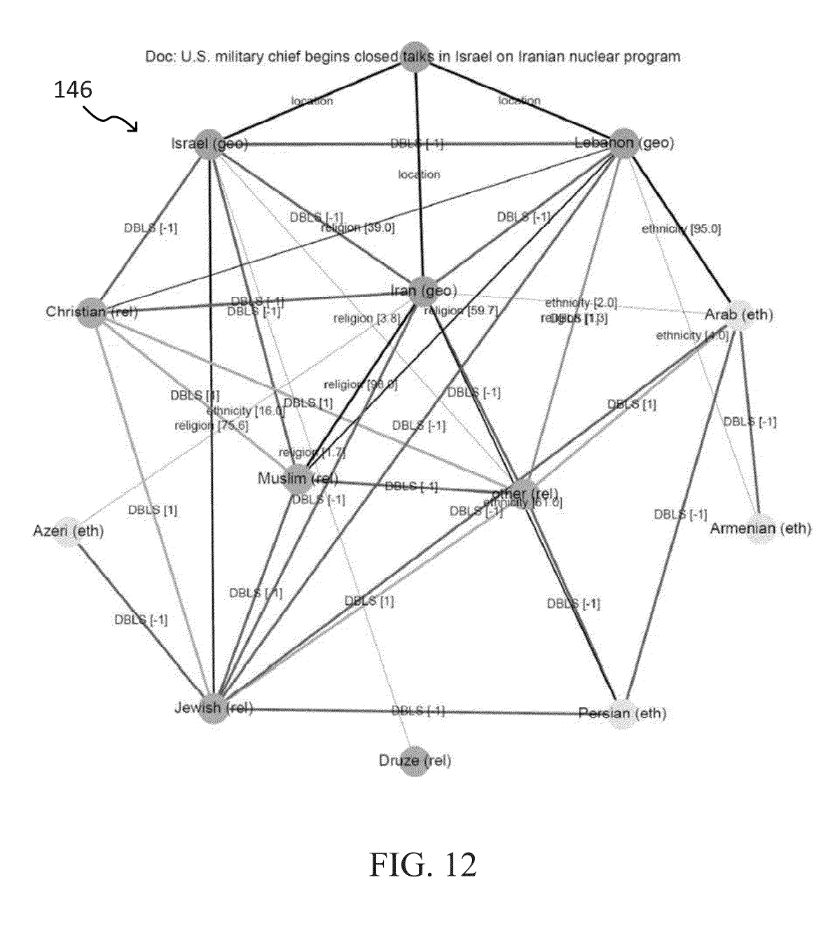

FIG. 12 is an example of a set of links 146 between a document and a contextual ontology. The document in this example is “U.S. military chief begins closed talks in Israel on Iranian nuclear program.” Within the ontology, as previously described, nodes are linked structurally (e.g., percentage of religion or ethnicity) or with a data-driven DBLS score, where the sentiment of the links could be color coded (e.g., positive links in green and negative links in red). Traversing the relationships between the entities related to the document of interest reveals the context around the document and thereby whether the sentiment of the document is anomalous in context.

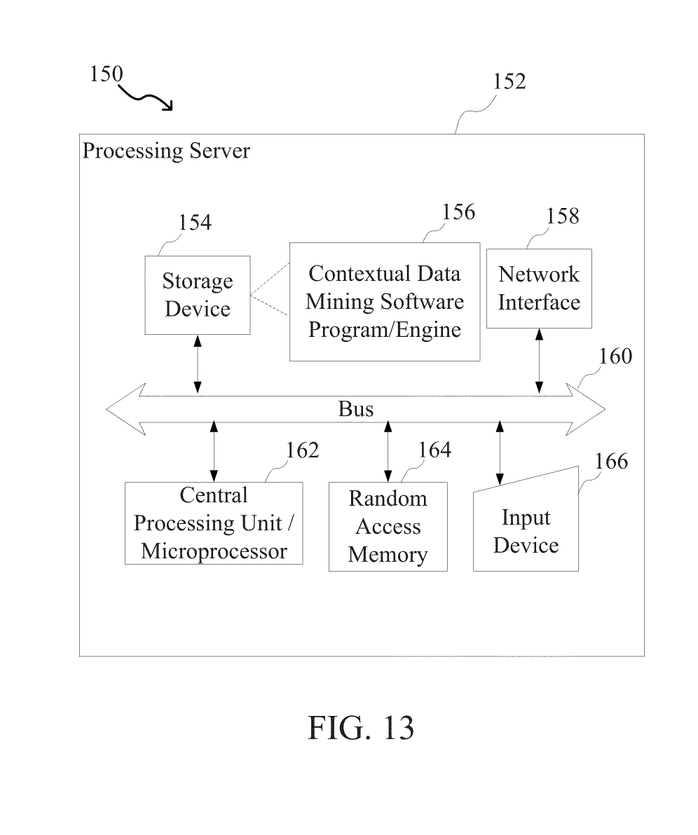

FIG. 13 is a diagram showing hardware and software components of a computer system 150 capable of performing the processes discussed in FIGS. 1-10 above. The system 150 (computer) comprises a processing server 152 which could include a storage device 154, a network interface 158, a communications bus 160, a central processing unit (CPU) (microprocessor) 162, a random access memory (RAM) 164, and one or more input devices 166, such as a keyboard, mouse, etc. The server 152 could also include a display (e.g., liquid crystal display (LCD), cathode ray tube (CRT), etc.). The storage device 154 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 152 could be a networked computer system, a personal computer, a smart phone, etc.

The functionality provided by the present invention could be provided by a contextual data mining program/engine 156, which could be embodied as computer-readable program code stored on the storage device 154 and executed by the CPU 162 using any suitable, high or low level computing language, such as Java, C, C++, C#, .NET, MATLAB, etc. The network interface 158 could include an Ethernet network interface device, a wireless network interface device, or any other suitable device which permits the server 152 to communicate via the network. The CPU 162 could include any suitable single- or multiple-core microprocessor of any suitable architecture that is capable of implementing and running the secure document distribution program 156 (e.g., Intel processor). The random access memory 164 could include any suitable, high-speed, random access memory typical of most modern computers, such as dynamic RAM (DRAM), etc.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention. What is desired to be protected is set forth in the following claims.

What is claimed is:

1. A system for data mining using domain-level context comprising:
a computer system in communication with a data source;
a contextual data mining engine executed by the computer system, the data mining engine including:
a document processing module for electronically mining, compiling, and processing documents from the data source;
a text analytics module for calculating a document-based score for each document;
a contextual ontology module for generating and storing one or more contextual ontologies, wherein each contextual ontology comprises a plurality of nodes interconnected by links, each node represents an entity, and each link has one or more corresponding link scores;
a user query module for allowing a user to query for documents of interest, wherein the contextual ontology module retrieves documents of interest based on the query; and
a visualization interface for presenting the retrieved documents of interest to the user.

2. The system of claim 1, wherein each link has a plurality of different types of link scores.

3. The system of claim 2, wherein the different types of link scores include a sentiment link score, a threat link score, and an influence link score.

4. The system of claim 2, wherein the different types of link scores include a document-based link score, an ontology-based link score, and an expert-based link score.

5. The system of claim 2, wherein the contextual ontology module further calculates one or more average link scores for each link by aggregating link scores of the same type.

6. The system of claim 5, wherein the contextual data mining engine automatically detects an anomaly by comparing the document-based score with the one or more average link scores and determining whether the difference exceeds a threshold.

7. The system of claim 5, wherein the contextual ontology module further calculates a contextual document score for each document by aggregating the average link scores for each pair of entities within the document.

8. The system of claim 7, wherein the contextual data mining engine automatically detects an anomaly by comparing the document-based score with the contextual document score and determining whether the difference exceeds a threshold.

9. The system of claim 1, wherein the text analytics module utilizes text analytics algorithms, and wherein the text analytics algorithms include a sentiment algorithm, a threat algorithm, an influence algorithm, and an anomalies algorithm.

10. The system of claim 1, wherein the visualization interface is a heatmap visualization interface.

11. A method for data mining using domain-level context information, comprising the steps of:
executing by a computer system a contextual data mining engine;
electronically mining, compiling, and processing documents from one or more sources using a document processing module;
calculating a document-based score for each document using a text analytics module;
generating and storing one or more contextual ontologies using a contextual ontology module, wherein each contextual ontology comprises a plurality of nodes interconnected by links, each node represents an entity, and each link has one or more corresponding link scores;
querying for documents of interest by a user using a user query module;
retrieving documents of interest based on the query; and
presenting the retrieved documents of interest to the user through a visualization interface.

12. The method of claim 11, wherein each link has a plurality of different types of link scores.

13. The method of claim 12, wherein the different types of link scores include a sentiment link score, a threat link score, and an influence link score.

14. The method of claim 12, wherein the different types of link scores include a document-based link score, an ontology-based link score, and an expert-based link score.

15. The method of claim 12, further comprising calculating one or more average link scores for each link by aggregating link scores of the same type.

16. The method of claim 15, further comprising automatically detecting an anomaly by comparing the document-based score with the one or more average link scores and determining whether the difference exceeds a threshold.

17. The method of claim 15, further comprising calculating a contextual document score for each document by aggregating the average link scores for each pair of entities within the document.

18. The method of claim 17, further comprising automatically detecting an anomaly using the contextual data mining engine by comparing the document-based score with the contextual document score and determining whether the difference exceeds a threshold.

19. The method of claim 11, wherein the text analytics module utilizes text analytics algorithms, and wherein the text analytics algorithms include a sentiment algorithm, a threat algorithm, an influence algorithm, and an anomalies algorithm.

20. The method of claim 11, wherein the visualization interface is a heatmap visualization interface.

21. A computer-readable medium having computer-readable instructions stored thereon which, when executed by a computer system, cause the computer system to perform the steps of:
executing by the computer system a contextual data mining engine;
electronically mining, compiling, and processing documents from one or more sources using a document processing module;
calculating a document-based score for each document using a text analytics module;
generating and storing one or more contextual ontologies using a contextual ontology module, wherein each contextual ontology comprises a plurality of nodes interconnected by links, each node represents an entity, and each link has one or more corresponding link scores;
querying for documents of interest by a user using a user query module;
retrieving documents of interest based on the query; and
presenting the retrieved documents of interest to the user through a visualization interface.

22. The computer-readable medium of claim 21, wherein each link has a plurality of different types of link scores.

23. The computer-readable medium of claim 22, wherein the different types of link scores include a sentiment link score, a threat link score, and an influence link score.

24. The computer-readable medium of claim 22, wherein the different types of link scores include a document-based link score, an ontology-based link score, and an expert-based link score.

25. The computer-readable medium of claim 22, further comprising calculating one or more average link scores for each link by aggregating link scores of the same type.

26. The computer-readable medium of claim 25, further comprising automatically detecting an anomaly by comparing the document-based score with the one or more average link scores and determining whether the difference exceeds a threshold.

27. The computer-readable medium of claim 25, further comprising calculating a contextual document score for each document by aggregating the average link scores for each pair of entities within the document.

28. The computer-readable medium of claim 27, further comprising automatically detecting an anomaly using the contextual data mining engine by comparing the document-based score with the contextual document score and determining whether the difference exceeds a threshold.

29. The computer-readable medium of claim 21, wherein the text analytics module utilizes text analytics algorithms, and wherein the text analytics algorithms include a sentiment algorithm, a threat algorithm, an influence algorithm, and an anomalies algorithm.

30. The computer-readable medium of claim 21, wherein the visualization interface is a heatmap visualization interface.
